(19) United States
(12) Patent Application Publication
(10) Pub. No.: US 2010/0053048 A1
(43) Pub. Date: Mar. 4, 2010

(54) DISPLAY APPARATUS AND DIGITAL PHOTO FRAME CAPABLE OF INDICATING RECEPTION OF E-MAIL AND METHOD FOR PROVIDING E-MAIL SERVICE APPLIED THERETO

(75) Inventors: Bo-kyun KWON, Suwon-si (KR); Hyun-sig LIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/394,401

(22) Filed: Feb. 27, 2009

(30) Foreign Application Priority Data
Sep. 2, 2008 (KR) 10-2008-0086326

(51) Int. Cl. G09G 3/36; G06F 3/048; G06F 3/00; G06F 15/16

(52) U.S. Cl. 345/87; 715/752; 715/748; 709/206

(57) ABSTRACT

A display apparatus, a digital photo frame and a method for indicating a reception of an e-mail message are provided. A display apparatus includes an indicator which is disposed separately from a screen of the display apparatus, and indicates that a new e-mail message is received; and a manipulation unit which inputs a command for performing operations related to the e-mail message. Therefore, a user can conveniently check reception of a new e-mail message using a digital photo frame.

### CROSS-REFERENCE TO RELATED APPLICATIONS

This application claims priority under 35 U.S.C. §119 from Korean Patent Application No. 10-2008-0086326, filed on Sep. 2, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus, a digital photo frame, and a method for providing an e-mail service applied thereto, and more particularly, to a display apparatus capable of indicating a reception of an e-mail, a digital photo frame, and a method for providing an e-mail service applied thereto.

2. Description of the Related Art

Digital photo frames read and store images photographed by a digital camera or images stored on a personal computer (PC), and display the images on a liquid crystal display (LCD). That is, a digital photo frame is a picture frame that displays digital photos without the need to print the photos or use a computer.

A user stores image data photographed using a digital camera or scanned using a scanner and compressed using a codec, in a memory of a digital camera or a PC as files, transmits the image files to a digital photo frame using a mobile storage medium such as a universal serial bus (USB) memory, and stores the image files in the digital photo frame.

As it is possible for a digital photo frame to be connected to the Internet, a user may transmit an image file to a digital photo frame using e-mail. However, a digital photo frame does not support input apparatuses such as keyboards so it is difficult for a user to check e-mail on the digital photo frame. Furthermore, large numbers of processes are required to check e-mail on the digital photo frame, and thus a user may experience inconvenience.

Therefore, there is a need for methods for a user to more conveniently check the reception of e-mail.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

Aspects of the present invention provide a display apparatus which indicates a reception of a new e-mail message using an indicator disposed separately from a screen on the display apparatus, and provides operations related to an e-mail service using a manipulation unit disposed on a position corresponding to the indicator so that a user may easily check the reception of an e-mail message through a digital photo frame, and a method for providing an e-mail service applied thereto.

Another aspect of the present invention provides a digital photo frame which indicates reception of an e-mail message by changing an emitting state of one among at least one light emitting element disposed separately from a screen.

According to an exemplary aspect of the present invention, there is provided a display apparatus, including an indicator which is disposed separately from a screen of the display apparatus, and indicates that a new e-mail message is received; and a manipulation unit which inputs a command for performing operations related to the e-mail message.

The manipulation unit may include a button to input a command for displaying an image file attached to the e-mail message on the screen.

The manipulation unit may be disposed to overlap with the indicator.

The indicator may be positioned on an area adjacent to the manipulation unit.

The indicator may indicate that the new e-mail message is received using at least one light emitting element.

The manipulation unit may be disposed so that light emitted from the light emitting element illuminates a rear surface of the manipulation unit.

The manipulation unit may include a touch sensitive button.

The manipulation unit may include a mechanical button.

If a new e-mail message is received, the indicator may indicate that the new e-mail message is received for a predetermined time, and if a user manipulates the manipulation unit within the predetermined time, the manipulation unit may input a command for performing operations related to the e-mail message.

The manipulation unit may include a button to input a command to display an image file attached to the received e-mail message on the screen as a background and display content of the e-mail message on the background.

The apparatus may further include a storage unit which stores an image file attached to the e-mail message in a predetermined folder, if the manipulation unit is manipulated.

The apparatus may further include a controlling unit which adds an image file attached to the e-mail to a list of image files displayed on the screen, if the manipulation unit is manipulated.

The apparatus may further include a display unit which displays an image file attached to the e-mail message together with information regarding a sender of the e-mail message on the screen, if the manipulation unit is manipulated.

The display apparatus may include functions of a digital photo frame.

According to another exemplary aspect of the present invention, there is provided a method for providing an e-mail service of a display apparatus comprising at least one light emitting element disposed separately from a screen of the display apparatus and a button corresponding to the at least one light emitting element, the method including if a new e-mail message is received, indicating that the new e-mail message is received using the at least one light emitting element; and if the button is manipulated while reception of the e-mail message is indicated, performing operations related to the e-mail message.

The performing may include displaying an image file attached to the e-mail message on the screen.

The indicating may include indicating that the e-mail is received by flickering one among the at least one light element.

If a new e-mail message is received, the indicating may indicate that the new e-mail message is received for a predetermined time, and if the button is manipulated within the predetermined time, the performing may perform operations related to the e-mail message.

The performing may display an image file attached the e-mail message on the screen as a background and displaying content of the e-mail message on the background.

The method may further include if the button is manipulated, storing an image file attached to the e-mail message in a predetermined folder.

The method may further include if the button is manipulated, adding an image file attached to the e-mail message to a list of image files displayed on the screen.

The method may further include if the button is manipulated, displaying an image file attached to the e-mail message together with information regarding a sender of the e-mail message on the screen.

The display apparatus may include a digital photo frame.

According to another exemplary aspect of the present invention, there is provided a digital photo frame, including at least one light emitting element which is disposed separately from a screen; and a controlling unit which controls the at least one light emitting element so that an emitting state of one of the light emitting element is changed, if a new e-mail message is received.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a digital photo frame according to an exemplary embodiment of the present invention;

FIG. 2 is a flowchart provided to explain a method for providing an e-mail service of a digital photo frame according to an exemplary embodiment of the present invention;

FIG. 3 is a front view illustrating a digital photo frame according to an exemplary embodiment of the present invention;

FIG. 4 is a side sectional view of a digital photo frame in which a manipulation unit and an indicator overlap according to an exemplary embodiment of the present invention;

FIGS. 5A, 5B and 5C are views illustrating a process in which a user manipulates a manipulation unit according to an exemplary embodiment of the present invention;

FIG. 6 is a view illustrating a digital photo frame in which an indicator is disposed on an upper portion of a manipulation unit according to another exemplary embodiment of the present invention; and

FIG. 7 is a screen on which an attached image file is displayed as a background and content of the e-mail message is displayed according to another exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. However, exemplary embodiments of the present invention can be carried out without those specifically defined matters. Also, well-known functions or constructions are not described in detail since they would obscure the invention with unnecessary detail.

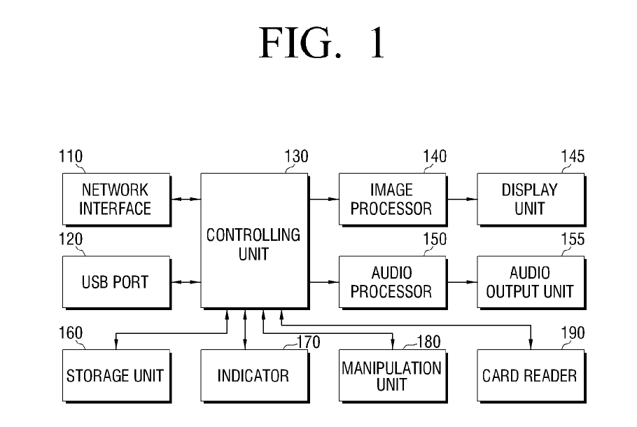

FIG. 1 is a block diagram illustrating a digital photo frame according to an exemplary embodiment of the present invention. Referring to FIG. 1, a digital photo frame may comprise a network interface 110, a Universal Serial Bus (USB) port 120, a controlling unit 130, an image processor 140, a display unit 145, an audio processor 150, an audio output unit 155, a storage unit 160, an indicator 170, and a manipulation unit 180.

The network interface 110 is connected to the Internet to communicate via a wired connection or wirelessly, and enables a user to use an Internet service on a digital photo frame. Specifically, a digital photo frame may receive an e-mail message from the Internet via the network interface 110. The network interface 110 may be constructed using a wired local area network (LAN) card, a wireless LAN (802.11a/b/g/n), or the like.

The USB port 120 may be connected to external apparatuses using a USB terminal. For example, the USB port 120 may connect the digital photo frame to a USB memory, and thus a digital photo frame stores image files from the USB memory in the storage unit 160 or displays the image files on the display unit 145.

While a storage medium is connected to a digital photo frame using a USB port in this exemplary embodiment of the present invention, the digital photo frame may also support other storage media. For example, the digital photo frame may comprise a compact disc (CD) drive, a Digital Versatile Disc (DVD) drive, a card reader, or the like.

The image processor 140 may process image signals input from the controlling unit 130 by video decoding, video scaling, or the like. The image processor 140 may output the image signals to the display unit 145.

The display unit 145 may display an image of the image signals output from the image processor 140. Specifically, the display unit 145 displays image files attached to an e-mail message on a screen. The display unit 145 may display information regarding an e-mail sender together with the image file attached to the e-mail message. The information regarding an e-mail sender may comprise an e-mail address, a name, an e-mail identification (ID), or the like. A user can thereby check who sent the e-mail message.

The audio processor 150 may process audio signals input from the controlling unit 130 by audio decoding, or the like. The audio processor 150 may output the audio signals to the audio output unit 155.

The audio output unit 155 may output audio output from the audio processor 150 via a speaker.

The storage unit 160 may store image files or audio files received through the network interface 110 or the USB port 120. The storage unit 160 transmits the image files to be displayed to the controlling unit 130. The storage unit 160 may be a hard disc, a non-volatile memory, or the like.

If the manipulation unit 180 is manipulated, the storage unit 160 may store image files attached to an e-mail message in a specific folder. A user may easily recognize the image files received via e-mail by checking the specific folder.

A card reader 190 may mount various types of memory cards, and retrieve data such as image files stored in the memory card mounted therein. The card reader 190 may mount a Compact Flash (CF) card, a Secure Digital (SD) card, a Memory Stick (MS), a Multi-Media (MM) card, an eXtream Digital (XD) card, a Smart Media (SM) card, or a Trans-Flash (TF) card.

The indicator 170 is disposed separately from a screen of the display unit 145, and indicates that a new e-mail message is received through the network interface 110. Specifically, the indicator 170 indicates the reception of a new e-mail message using at least one light emitting element. If a new e-mail message is received, the indicator 170 changes an emitting state of one of one or more light emitting elements.

For example, if the digital photo frame receives a new e-mail message through the network interface 110, the indicator 170 may change the light emitting element from being turned off to being turned on, thereby indicating that a new e-mail message is received. When a new e-mail message is received, the indicator 170 may indicate the reception of the e-mail message by flickering or turning off a light emitting element.

If a new e-mail message is received, the indicator may indicate the reception of the new e-mail message for a predetermined time, and return to the original state after the predetermined time has elapsed.

The indicator 170 may be any element which emits light. For example, the indicator 170 may be implemented as a light emitting diode (LED), an Organic Electro Luminescence (OEL), or the like.

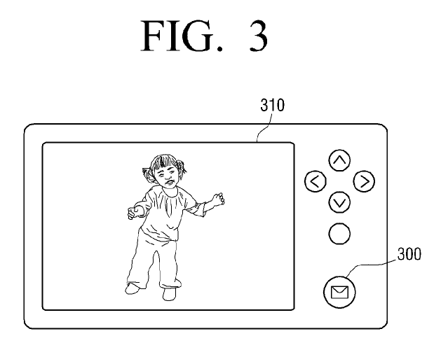

The indicator 170 may be positioned to correspond to the manipulation unit 180 which causes operations related to e-mail to be performed. For example, the indicator 170 may be positioned to overlap with the manipulation unit 180 so as to illuminate a rear surface of the manipulation unit 180. The indicator 170 may be positioned on upper portion of the manipulation unit 180. The position of the indicator 170 and the manipulation unit 180 will be explained in detail with reference to FIGS. 3, 4 and 6.

The manipulation unit 180 is positioned to correspond to the indicator 170, and is provided to input a command for performing operations related to e-mail. If a user manipulates the manipulation unit 180, the digital photo frame performs operations related to e-mail.

The manipulation unit 180 may comprise a button to input a command to display an image file attached to an e-mail message on a screen of the display unit 145. The manipulation unit 180 may be implemented as a touch sensitive button or a mechanical button.

If the indicator 170 indicates that a new e-mail message is received, and if a user manipulates the manipulation unit 180, the display unit 145 may display an image file attached to the e-mail message.

The manipulation unit 180 may comprise a button to input a command to display an image file attached to an e-mail message on a screen of the display unit 145 as a background, and displaying content of the e-mail message on the background.

If the indicator 170 indicates that a new e-mail message is received, and if a user manipulates the button of the manipulation unit 180, the display unit 145 may display an image file attached to the e-mail message on a screen of the display unit 145 as a background, and display content of the e-mail message on the background.

The manipulation unit 180 may be constructed to input commands for performing various operations related to e-mail other than the above operations.

If a user manipulates the manipulation unit 180 within a predetermined time during which the indicator 170 indicates the reception of an e-mail, the manipulation unit 180 may be constructed to input commands for performing operations related to the e-mail message. That is, the manipulation unit 180 receives commands for performing operations related to e-mail when a user manipulates the manipulation unit 180 while the indicator 170 is indicating the reception of a new e-mail message.

If the manipulation unit 180 is not manipulated for a predetermined time during which the reception of an e-mail message is indicated, the controlling unit 130 controls the digital photo frame to operate according to a predetermined mode which is preset by a user.

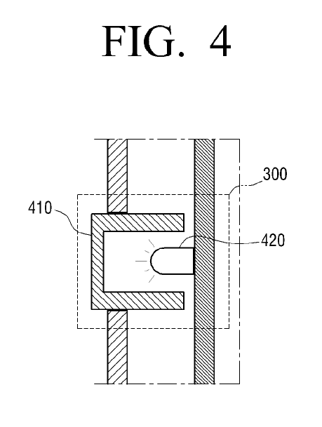

The manipulation unit 180 may be positioned to overlap with the indicator 170. Specifically, the manipulation unit 180 may be positioned to overlap with the indicator 170 so that light emitted from the indicator 170 illuminates the rear surface of the manipulation unit 180. The position of the manipulation unit 180 and the indicator 170 will be explained with reference to FIGS. 3 and 4.

FIG. 3 is a front view illustrating a digital photo frame according to an exemplary embodiment of the present invention. Referring to FIG. 3, a face of the digital photo frame may comprise a screen 310 and an indication and manipulation unit 300. The screen 310 may display photographs.

Referring to FIG. 3, the indication and manipulation unit 300 is disposed separately from the screen 310. The indication and manipulation unit 300 is constructed by overlapping a light emitting element corresponding to the indicator 170 with a button corresponding to the manipulation unit 180. The light emitting element of the indication and manipulation unit 300 is disposed behind the button, thereby illuminating a rear surface of the button.

FIG. 4 is a side sectional view of a digital photo frame in which a manipulation unit and an indicator overlap according to an exemplary embodiment of the present invention. Referring to FIG. 4, the indication and manipulation unit 300 may comprise a button 410 corresponding to the manipulation unit 180 and a light emitting element 420 corresponding to the indicator 170. The light emitting element 420 is positioned to illuminate a rear surface of the button 410.

If the button 410 and the light emitting element 420 overlap each other, a user may intuitively recognize the function of the light emitting element 420, that is whether an e-mail is received and what is the button 410 to perform operations related to the received e-mail.

As the light emitting element 420 is disposed separately from the screen 310, a user may check that a new e-mail is received without disturbing a currently displayed photo.

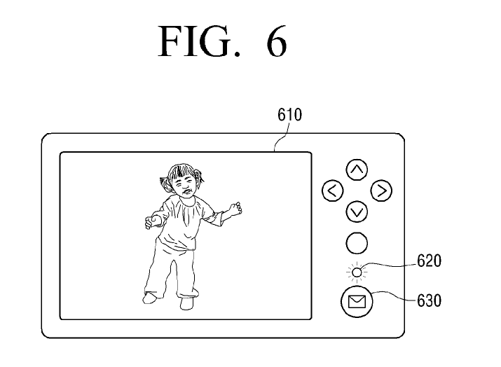

The indicator 170 and the manipulation unit 180 may be disposed in a different manner. For example, the indicator 170 may be positioned on an area adjacent to the manipulation unit 180. A case in which the indicator 170 is positioned on an upper portion of the manipulation unit 180 will be explained with reference to FIG. 6.

FIG. 6 is a view illustrating a digital photo frame in which an indicator is disposed on an upper portion of a manipulation unit according to another exemplary embodiment of the present invention. Referring to FIG. 6, a face of the digital photo frame may comprise a screen 610, a light emitting element 620 corresponding to the indicator 170, and a button 630 corresponding to the manipulation unit 180.

The light emitting element 620 and the button 630 are disposed separately from the screen 610 as shown in FIG. 6. The light emitting element 620 is positioned on an upper portion of the button 630. A user may thereby recognize that a new e-mail message is received through the light emitting element 620 and that the button to input commands for performing operations corresponding to the e-mail message is the button 630 below the light emitting element 620.

If the manipulation unit 180 is positioned to correspond to the indicator 170, a user may intuitively recognize what the indicator 170 corresponding to the manipulation unit 180 indicates.

The controlling unit 130 may recognize a user command based on a user's manipulation transmitted from various input apparatuses, such as a remote control (not shown), and control overall operations of the digital photo frame according to the user command or according to a preset algorithm.

The controlling unit 130 receives an e-mail message through the network interface 110. The controlling unit 130 may provide services related to the reception of an e-mail using various protocols, including the Post Office Protocol version 3 (POP3).

The controlling unit 130 periodically checks whether a new e-mail message is received. The interval for checking e-mail messages may be preset or may be set by a user.

The controlling unit 130 may enable the only e-mail from a predetermined sender to be received. As unnecessary junk mail is commonly received, the controlling unit 130 may set a list of e-mail addresses which a user desires to receive, and may enable e-mail from addresses included in the list to be received.

The controlling unit 130 controls the indicator 170 to indicate that a new e-mail message is received. For example, if a new e-mail message is received, the controlling unit 130 controls light emitting elements included in the indicator 170 so that an emitting state of at least one light emitting element is changed.

If the manipulation unit 180 is manipulated, the controlling unit 130 causes operations related to e-mail to be performed. For example, if the button included in the manipulation unit 180 is pressed, image files attached to a newly received e-mail message are displayed on the screen under the control of the controlling unit 180. Alternatively, if the button included in the manipulation unit 180 is pressed, image files attached to a newly received e-mail messaged is displayed on the screen as a background, and content of the e-mail message is displayed on the background under the control of the controlling unit 130.

If a plurality of e-mail messages are received, the controlling unit 130 may execute a slideshow which displays sequentially a series of image files attached to the plurality of e-mail messages. If an e-mail message includes a plurality of image files, the controlling unit 130 may execute a slideshow which displays sequentially the plurality of image files.

If an e-mail message is received, the controlling unit 130 may control the indicator 170 to indicate reception of a new e-mail message for a predetermined time. If a user manipulates the manipulation unit 180 within the predetermined time during which the reception of a new e-mail is indicated, the controlling unit 130 may cause the operations related to e-mail to be performed.

If the manipulation unit 180 is manipulated, the controlling unit 130 may add an image file attached to an e-mail message to a list of image files displayed on the screen. Herein, the list of image files displayed on the screen represents a list of image files being displayed as a slideshow. Image files received via e-mail are automatically added to a list of image files to be displayed as a slideshow, and thus a user may more conveniently view image files received via e-mail.

If a user does not manipulate the manipulation unit 180 within the predetermined time during which the reception of a new e-mail is indicated, the controlling unit 130 may control the digital photo frame to operate according to a mode preset by a user. The preset mode may comprise a display mode in which image files attached to an e-mail message are displayed on a screen, a storing mode in which image files attached to an e-mail message are stored in a specific folder, an adding mode in which image files attached to an e-mail message are added to a list of image files to be displayed as a slide show, or the like.

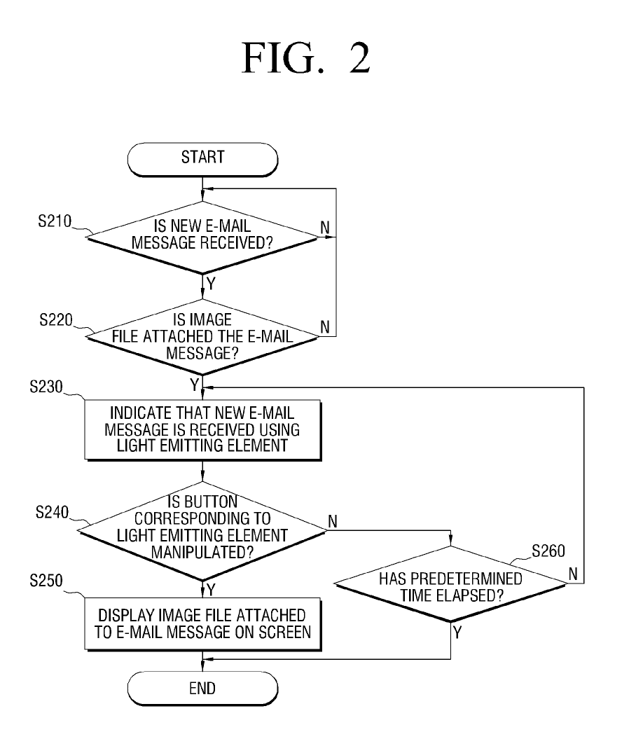

A method for providing an e-mail service of a digital photo frame will be explained with reference to FIG. 2. FIG. 2 is a flowchart provided to explain a method for providing an e-mail service of a digital photo frame according to an exemplary embodiment of the present invention.

The digital photo frame determines whether a new e-mail message is received (S210). If it is determined that a new e-mail message is received (S210-Y), the digital photo frame determines whether an image file is attached to the e-mail message (S220).

If it is determined that an image file is attached to the e-mail message (S220-Y), the digital photo frame indicates that a new e-mail message is received using at least one light emitting element (S230). The digital photo frame may flicker or radiate one among at least one light emitting element in order to indicate the reception of a new e-mail message. At least one light emitting element corresponds to the indicator 170.

In operation S220, when an e-mail message including an image file is received, the digital photo frame determines that a new e-mail is received. Alternatively, reception of a new e-mail message may be indicated irrespective of whether or not an image file is included, that is without performing operation S220.

The digital photo frame determines whether a button corresponding to the light emitting element is manipulated (S240). The button corresponds to the manipulation unit 180. If the button is manipulated, that is, if the button is pressed (S240-Y), an image file attached to an e-mail message is displayed on a screen (S250). The digital photo frame may also display the image file attached to the e-mail message together with information regarding the sender of the e-mail message. Accordingly, a user may easily recognize who transmits the e-mail message.

If it is determined that a button is not manipulated (S240-N), the digital photo frame determines that a predetermined time has elapsed (S260). If a predetermined time has not elapsed (S260-N), the digital photo frame keeps the light emitting element indicating that a new e-mail is received (S230), and determines whether the corresponding button is manipulated (S240). If a predetermined time has elapsed (S260-Y), the digital photo frame stops indicating that a new e-mail message is received, or operates according to user's preset setting.

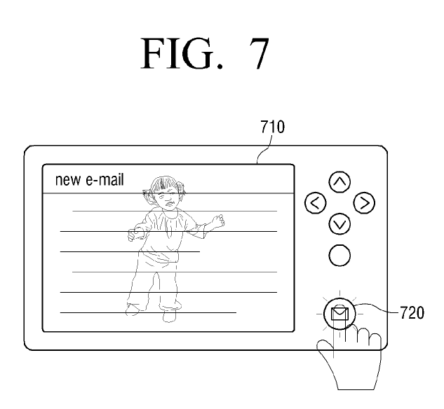

While an image file attached to an e-mail message is displayed on a screen in operation S250, other operations related to e-mail may also be performed. For example, if the corresponding button is manipulated (S240-Y), the digital photo frame may display an image file attached to an e-mail message on the screen as a background, and display content of the e-mail message on the background. This will be explained with reference to FIG. 7.

If the corresponding button is manipulated (S240-Y), the digital photo frame may also store an image file attached to an e-mail message in a specific folder of the storage unit 160. A user may conveniently find the image file of the e-mail by checking the specific folder.

If the corresponding button is manipulated (S240-Y), the digital photo frame may add an image file attached to an e-mail message to a list of image files displayed on the screen. Herein, the list of image files displayed on the screen represents a list of image files being displayed as a slide show. Image files received via e-mail are automatically added to a list of image files to be shown as a slideshow, and thus a user may more conveniently view the image files received via e-mail.

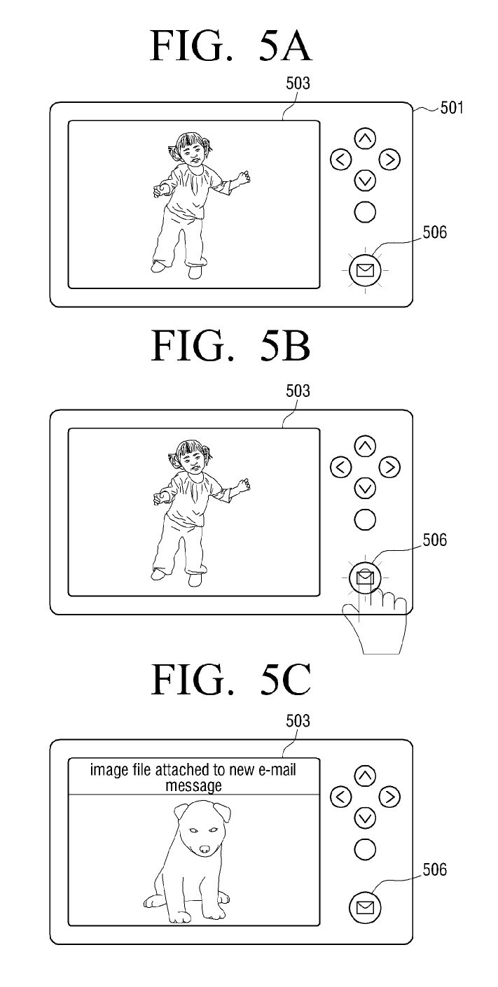

In doing so, a method for providing an e-mail service of a digital photo frame may be implemented. Hereinbelow, the process of performing the above operations will be explained with reference to FIGS. 5A to 5C.

FIGS. 5A to 5C are views illustrating a process in which a user manipulates a manipulation unit according to an exemplary embodiment of the present invention. Referring to FIG. 5A, a digital photo frame 501 indicates that a new e-mail is received. A screen 503 displays a photograph, and an indication and manipulation unit 506 emits light to indicate that a new e-mail message is received. The indication and manipulation unit 506 means a button in which the indicator 170 and the manipulation unit 180 overlap.

While reception of a new e-mail message is indicated, a user may press the indication and manipulation unit 506 constructed as a button as shown in FIG. 5B. If a user presses the indication and manipulation unit 506, the digital photo frame may display an image file attached to a newly received e-mail message on the screen 503 as shown in FIG. 5C.

The digital photo frame may provide a function of displaying an image file attached to an e-mail message as a background, and may additionally provide a function of displaying other content of an e-mail message on the background. This will be explained with reference to FIG. 7.

FIG. 7 is a screen on which an attached image file is displayed as a background and content of the e-mail message is displayed according to another exemplary embodiment of the present invention. Referring to FIG. 7, if a user presses an indication and manipulation unit 720, the digital photo frame may display an image file attached to a received e-mail message on a screen 710 as a background and display content of the e-mail message on the background.

As described above, the digital photo frame may provide various functions related to an e-mail service. If an e-mail message is received, reception of e-mail message is indicated on the indicator 170 disposed separately from the screen. Accordingly, a user may determine whether an e-mail message is received while viewing a photograph displayed on the screen. The manipulation unit 180 is positioned to correspond to the indicator 170, and thus a user may intuitively recognize the function of the manipulation unit 180.

While the digital photo frame is provided as a display apparatus in this exemplary embodiment of the present invention, any display apparatus which receives an e-mail message and displays the e-mail message on a screen may be applied to exemplary embodiments of the present invention.

According to exemplary embodiments of the present invention, a user may easily recognize reception of an e-mail message through a digital photo frame since a display apparatus having an indicator, disposed separately from the screen, which indicates reception of a new e-mail and a manipulation unit disposed to correspond to the indicator which causes operations related to an e-mail service to be performed, and a method for providing an e-mail service are provided.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus, which receives a new e-mail message, the apparatus comprising:
a display screen which displays an image;
an indicator which is disposed separately from the display screen, and indicates that the new e-mail message is received; and
a manipulation unit which inputs a command for performing operations related to the new e-mail message.

2. The apparatus of claim 1, wherein the manipulation unit comprises a button to input a command for displaying an image file attached to the new e-mail message on the display screen.

3. The apparatus of claim 1, wherein the manipulation unit is a remote control device including a button to input a command for displaying an image file attached to the new e-mail message on the display screen.

4. The apparatus of claim 1, wherein the manipulation unit is disposed to overlap with the indicator.

5. The apparatus of claim 1, wherein the indicator is positioned on an area adjacent to the manipulation unit.

6. The apparatus of claim 1, wherein the indicator indicates that the new e-mail message is received using at least one light emitting element.

7. The apparatus of claim 6, wherein the manipulation unit is disposed so that light emitted from the at least one light emitting element illuminates a rear surface of the manipulation unit.

8. The apparatus of claim 1, wherein the manipulation unit comprises a touch sensitive button.

9. The apparatus of claim 1, wherein the manipulation unit comprises a mechanical button.

10. The apparatus of claim 1, wherein if the new e-mail message is received, the indicator indicates that the new e-mail message is received for a predetermined time, and if a user manipulates the manipulation unit within the predetermined time, the manipulation unit inputs a command for performing operations related to the new e-mail message.

11. The apparatus of claim 1, wherein the manipulation unit comprises a button to input a command to display an image file attached to the new e-mail message on the display screen as a background and display content of the new e-mail message on the background.

12. The apparatus of claim 1, further comprising:
a storage unit which stores an image file attached to the new e-mail message in a predetermined folder, if the manipulation unit is manipulated.

13. The apparatus of claim 1, further comprising:
a controlling unit which adds an image file attached to the new e-mail to a list of image files displayed on the display screen, if the manipulation unit is manipulated.

14. The apparatus of clam 1, further comprising:
a display unit which displays an image file attached to the new e-mail message together with information regarding a sender of the new e-mail message on the display screen, if the manipulation unit is manipulated.

15. The apparatus of claim 1, wherein the display apparatus is a digital photo frame.

16. The apparatus of claim 1, further comprising a controlling unit which periodically checks whether an e-mail message is received, wherein an interval for checking whether the e-mail message is received may be preset or may be set by a user.

17. The apparatus of claim 1, further comprising a controlling unit which enables only e-mail from at least one predetermined sender to be received.

18. The apparatus of claim 1, further comprising a controlling unit
wherein if a plurality of e-mail messages are received, the controlling unit executes a first slideshow which displays image files attached to the plurality of e-mail messages, and
wherein if the received new e-mail message includes a plurality of image files, the controlling unit executes a second slideshow which displays the plurality of image files.

19. A method for providing an e-mail service of a display apparatus comprising at least one light emitting element disposed separately from a screen of the display apparatus and a manipulation unit corresponding to the at least one light emitting element, the method comprising:
if a new e-mail message is received, indicating that the new e-mail message is received using the at least one light emitting element; and
if the manipulation unit is manipulated while reception of the new e-mail message is indicated, performing operations related to the new e-mail message.

20. The method of claim 19, wherein the manipulation unit comprises a button to input a command for displaying an image file attached to the new e-mail message on the display screen.

21. The method of claim 19, wherein the manipulation unit is a remote control device including a button to input a command for displaying an image file attached to the new e-mail message on the display screen.

22. The method of claim 19, wherein the performing comprises:
displaying an image file attached to the new e-mail message on the screen.

23. The method of claim 19, wherein the indicating comprises:
indicating that the new e-mail is received by flickering one among the at least one light element.

24. The method of claim 19, wherein if the new e-mail message is received, the indicating indicates that the new e-mail message is received for a predetermined time, and if the manipulation unit is manipulated within the predetermined time, the performing performs operations related to the new e-mail message.

25. The method of claim 19, wherein the performing displays an image file attached the new e-mail message on the screen as a background and displaying content of the new e-mail message on the background.

26. The method of claim 19, further comprising:
if the manipulation unit is manipulated, storing an image file attached to the new e-mail message in a predetermined folder.

27. The method of claim 19, further comprising:
if the manipulation unit is manipulated, adding an image file attached to the new e-mail message to a list of image files displayed on the screen.

28. The method of clam 19, further comprising:
if the manipulation unit is manipulated, displaying an image file attached to the new e-mail message together with information regarding a sender of the new e-mail message on the screen.

29. The method of claim 19, wherein the display apparatus is a digital photo frame.

30. The apparatus of claim 19, further comprising periodically checking whether an e-mail message is received, wherein an interval for checking whether the e-mail message is received may be preset or may be set by a user.

31. The apparatus of claim 19, further comprising enabling only e-mail from at least one predetermined sender to be received.

32. The apparatus of claim 19, further comprising:
if a plurality of e-mail messages are received, executing a first slideshow which displays image files attached to the plurality of e-mail messages, and
if the received new e-mail message includes a plurality of image files, executing a second slideshow which displays the plurality of image files.

33. A digital photo frame, which receives a new e-mail message, the digital photo frame comprising:
a display screen which displays at least one digital photo;
at least one light emitting element which is disposed separately from the display screen; and
a controlling unit which controls the at least one light emitting element so that an emitting state of one of the at least one light emitting element is changed if the new e-mail message is received.
